(19) United States
(12) Patent Application Publication
(10) Pub. No.: US 2011/0279641 A1
(43) Pub. Date: Nov. 17, 2011

(54) APPARATUS, SYSTEMS, COMPUTER-ACCESSIBLE MEDIUM AND METHODS FOR VIDEO CROPPING, TEMPORALLY-COHERENT WARPING AND RETARGETING

(75) Inventors: YU-SHUEN WANG, Tainan City (TW); HUI-CHIH LIN, Puzi City (TW); OLGA SORKINE, Zurich (CH); TONG-YEE LEE, Kaohsiung City (TW)

(73) Assignees: NEW YORK UNIVERSITY, New York, NY (US); NATIONAL CHENG KUNG UNIVERSITY, Tainan City (TW)

(21) Appl. No.: 13/106,971

(22) Filed: May 13, 2011

Related U.S. Application Data
(60) Provisional application No. 61/334,953, filed on May 14, 2010.

(30) Foreign Application Priority Data
Aug. 13, 2010 (TW) 099127214
Aug. 13, 2010 (TW) 099127215
Aug. 13, 2010 (TW) 099127216
Aug. 13, 2010 (TW) 099127217
Aug. 13, 2010 (TW) 099127218
Aug. 13, 2010 (TW) 099127219

(51) Int. Cl. H04N 7/01; H04N 13/00

(52) U.S. Cl. 348/42; 348/441; 348/E07.003; 348/E13.001

(57) ABSTRACT

A method for warping a video is provided. The method for warping a video, comprising steps of (a) receiving a video having at least a frame having a specific area; (b) defining a target video cube having a predetermined warping ratio and including the specific area; and (c) warping the frame so that the warped frame conforms to an aspect ratio of the target video cube.

### CROSS-REFERENCES TO RELATED APPLICATIONS

This application claims the benefit of U.S. Provisional Application No. 61/334,953 filed on May 14, 2010 and TW patent Applications No. 099127214, 099127215, 099127216, 099127217, 099127218 and 099127219 filed on Aug. 13, 2010, the disclosures of which are incorporated herein in their entirety by reference.

### FIELD OF THE INVENTION

The present invention relates to a video playing system for displays, which implements a method of warping videos. In particular, the method combines cropping and warping videos, and includes the relevant devices and circuits thereof.

### BACKGROUND OF THE INVENTION

Retargeting images and video for display on devices with different resolutions and aspect ratios is an important issue to be solved, in particular for modern society where visual information can be accessed using a variety of display media, such as cellular phones, PDAs, widescreen television and notebook, etc, with different formats. To fully utilize the target screen resolution, conventional methods and/or procedures can homogeneously rescale or crop visual content to fit the aspect ratio of a target medium.

Simple linear scaling likely distorts the image content, and cropping can remove valuable visual information close to the frame periphery. To address this problem, content-aware retargeting techniques have been recently described. These methods can non-homogeneously deform images and video to the required dimensions, such that the appearance of visually important content can be preserved at the expense of removing or distorting less prominent parts of the input.

Many content-aware retargeting techniques to date have likely concentrated on spatial image information, such as various visual saliency measures and face/object detection, to define visually important parts of the media and to guide the retargeting process. They can rely on the notion that removing or distorting homogeneous background content can be less noticeable to the eye. Recently introduced video retargeting can work additionally average the per-frame importance maps over several frames and grant higher importance to moving objects to improve the temporal coherence of the result, for example.

However, video retargeting can be fundamentally different from still image retargeting and likely cannot be solved solely by augmenting image-based methods with temporal constraints. The reasons for this can be as follows.

(1) First, in video, motion and temporal dynamics can be the core considerations and can have to be explicitly addressed; simply smoothing the effect of the per-frame retargeting operator along the time axis, as was done in most previous works, likely cannot cope with complex motion flow and results in waving and flickering artifacts.

(2) Second, prominent objects can often cover most of the image, in which case any image based retargeting method can reach its limit, since retargeting can be impossible without removing and/or distorting important content. Even if each individual frame does contain some disposable content, the trajectories of the important objects can often cover the entire frame space. This can make it impossible to simultaneously preserve the shape of the important objects and retain temporal coherence.

### SUMMARY OF THE INVENTION

One of the objects of certain exemplary embodiments of the present disclosure can be to address the exemplary problems described herein above, and/or to overcome the exemplary deficiencies commonly associated with the prior art as, e.g., described herein.

Indeed, provided and described herein are exemplary embodiments according to the present disclosure of apparatus, systems, computer-accessible medium, methods and procedures for, e.g., identifying and/or determining at least one specific area in a video content to be protected from cropping during a video retargeting procedure. For example, a procedure according to certain exemplary embodiments of the present disclosure can include, e.g., receiving video data associated with at least one video frame. With a hardware processing arrangement, the exemplary procedure can also include determining information for at least one specific column and/or row. This determination can be made based on (i) content associated with the information appearing in a frame and/or configured to disappear within a specific number of next frames associated with the particular region(s), and/or (ii) the information containing actively moving foreground objects associated with the particular region(s). The exemplary procedure can further include determining the particular region(s) of the video frame(s) to be protected from being cropped based on the information.

For example, the region(s) can be determined based on optical flow, and the exemplary procedure can further include testing an average flow vector associated with each pixel related to information to determine whether the information appears in any specific frame of a previous number of k frames and remains visible in any of a subsequent number of j frames, where k and j can be integers. The information that fails the test can be marked. The actively moving foreground objects can be determined based on an entropy associated with the flow of information associated with each of the specific columns and/or rows. The entropy can be determined using quantized flow vectors and/or based on flow probabilities.

The exemplary procedure can further include selecting the specific column(s) and/or row(s) based on a specific flow entropy associated with the information of each of the specific columns and/or rows exceeding a predetermined threshold. The predetermined threshold can be a function of the maximum possible entropy associated with a uniform distribution of flows.

According to certain exemplary embodiments of the present disclosure, the exemplary procedure can further include performing a warping subprocess on the video data, where the particular regions are transformed within a target video cube. The exemplary warping subprocess can be performed using a warping function that is at least temporally coherent. An anchor vertex can be constrained to facilitate a smooth transition between neighboring frames.

The exemplary procedure can further include identifying mesh vertex positions, where the mesh vertex positions can be a linear combination of grid mesh vertices within a5 predetermined vicinity. Deformed grid mesh positions can be determined using an objective function and/or an iterative minimization function based on a least-squares technique. One or more particular regions can be predetermined in one or more key frames, which predetermination can be made automatically and/or by a human operator.

Additionally, the exemplary warping subprocess can use a grid mesh that includes a plurality of quads, and the exemplary procedure can further include determining at least one particular quad that has a flow vector extending outside of a particular video frame, where the particular quad(s) can have a size equal to a size of at least one further quad that is at least temporally adjacent to the particular quad(s), which can be constrained using a resizing procedure. The exemplary warping subprocess can use a pixel-level grid and/or sliding windows. Further, the exemplary procedure can further include the display and/or storage of the information in a storage arrangement a user-accessible format and/or a user-readable format.

Exemplary embodiments of computer-accessible medium and systems for facilitating the exemplary procedures described herein above are also described herein, for example.

Also provided herein is an exemplary procedure for processing video data to facilitate warping of at least one particular region in a video content during a video retargeting procedure. For example, the procedure according to certain exemplary embodiments of the present disclosure can include, e.g., receiving video data including information associated with at least one video frame. With a hardware processing arrangement, the exemplary procedure can also include determining information for at least one particular column and/or row. This determination can be made based on (i) content associated with the information appearing in a frame and/or configured to disappear within a particular number of next frames associated with the particular region(s), and/or (ii) the information containing actively moving foreground objects associated with the particular region(s). The exemplary procedure can further include determining the particular region(s) of the video frame(s) to be warped based on the information. The exemplary procedure can further include performing a warping procedure on the video data, where the particular region(s) can be transformed within a target video cube and be protected from being cropped during a cropping procedure, for example.

These and other objects, features and advantages of the present disclosure will become apparent upon reading the following detailed description of exemplary embodiments of the present disclosure, when taken in conjunction with the accompanying exemplary drawings and appended claims.

According to another aspect of the present invention, the present invention provides a video playing system for displays, including a processor to perform steps of: (a) receiving the film having at least a frame; (b) defining a three-dimensional image coordination of a target film having a predetermined warping ratio and a specific area; and (c) warping the frame so that the warped frame conforms to the three-dimensional image coordination, and the film has a new format for playing, so that the file has a new format for playing.

According to another aspect of the present invention, the present invention provides a video playing system for displays, including a processor to perform steps of: (a) receiving a plurality of frames; (b) defining a predetermined warping ratio proper to a respective specific area of each the frame; and (c) warping the each frame so that the respective warped frame thereof conforms to the respective predetermined warping ratio, so that the film has a new format for playing.

Other objects, advantages and efficacy of the present invention will be described in detail below taken from the preferred embodiments with reference to the accompanying drawings, in which:

### BRIEF DESCRIPTION OF THE DRAWINGS

FIG. 1 is a flow chart of the present invention;

FIG. 2 is a pie chart of the present invention;

FIGS. 3(a) and 3(b) are exemplary illustrations showing utilizing the method in accordance with the present invention to detect the left most and the right most boundaries of particular regions of the present invention;

FIGS. 4(a) and 4(b) are exemplary illustrations showing that the frames are warped in order to match the size ration of the target video cube;

FIGS. 5(a) and 5(b) are the grid charts of the present invention;

As shown in FIGS. 6(a)˜6(h), FIGS. 6 (a) and 6(e) are exemplary illustrations of the conventional methods, FIGS. 6(b) and 6(f) show the linear scaling frames, FIGS. 6 (c) and 6(g) are the figures processed in the prior art, and FIGS. 6 (d) and 6(h) show the embodiments of the present invention;

As shown in FIGS. 7(a)˜7(d), FIG. 7 (a) is an exemplary illustrations for the conventional methods, FIG. 7(b) shows the linear scaling frame, FIG. 7 (c) is the figure processed in the prior art, and FIG. 7 (d) shows the embodiment in accordance with the present invention;

FIGS. 8(a)˜8(d) are exemplary illustrations showing that the conventional content-aware video resizing methods can fail when a main subject overlaps with most of the background as a camera orbits/circles around the main subject when using the conventional methods in comparison to a procedure according to certain exemplary embodiments of the present disclosure, wherein FIG. 8(a) is an exemplary illustration of the conventional methods, FIG. 8(b) showing the linear scaling frame, FIG. 8(c) is the figure processed in the prior art, and FIG. 8(d) shows the embodiment in accordance with the present invention;

As shown in FIGS. 9(a)˜9(d), FIG. 9(a) is an exemplary illustrations of the conventional methods, FIG. 9(b) showing the linear scaling frame, FIG. 9(c) is the figure processed in the prior art, and FIG. 9(d) shows the embodiment in accordance with the present invention;

FIG. 10 is a system block diagram of the present invention;

FIG. 11 shows a flow chart according to a embodiment in accordance with the present invention;

FIG. 12(a) is a block diagram according to the video playing system of displays of the present invention;

FIG. 12(b) shows a flow chart according to another embodiment in accordance with the present invention.

FIG. 13(a) shows the video data processing system of the present invention;

FIG. 13(b) shows a flow chart according to another embodiment in accordance with the present invention.

FIG. 14(a) shows the touch control system of the present invention;

FIG. 14(b) shows a flow chart according to another embodiment in accordance with the present invention.

FIG. 15(a) shows the video output format system of the present invention;

FIG. 15(b) shows a flow chart according to another embodiment in accordance with the present invention.

FIG. 16(a) shows the warping graphic processing unit of the present invention;

FIG. 16(b) shows a flow chart according to another embodiment in accordance with the present invention.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION

Firstly, for the problem that the warping ratios of the videos having at least a frame in the mobile phones and PDAs will be different, important video objects are previously defined.

For the videos to be warped, important video objects included in a specific area in each frame are previously defined. For example, methods for the moving foreground objects to avoid to be cropped are as follows.

1. Count the optical flow of each frame. After quantitative analysis, the flow vector of each pixel in frames can be obtained.

2. Introduce all flow vectors to a fan chart to perform number counting, and introduce the probability distribution of the numbers to the entropy to obtain the entropy information of each column of at least a frame.

3. Find the particular region that is not allowed to be cropped by using each entropy of column of all frames.

4. Combine the cropping and warping to perform the optimized operation, so as to make the frames match the ration of the target video cube after warped.

In other words, through defining a particular region in each frame, the contents of each frame in the region must not be deleted. Use an optical flow to define these criteria and compute the particular region of the entire video cube. Content outside the particular regions can potentially be discarded. In particular, when narrowing a video, it is possible to look for critical (or particular) columns of pixels which should not be removed. When widening, it is possible to look at critical (or particular) rows. For brevity and assist in describing exemplary embodiments according to the present disclosure, only narrowing is mentioned/referenced herein below:

1. When the content just appear at frames or is about to disappear at the next frame, the content does not have the characteristic of continuously appearing at the timeline.

2. The actively moving foreground objects must be included in the particular region, and the leftmost column and the rightmost column of the particular region are defined as critical columns.

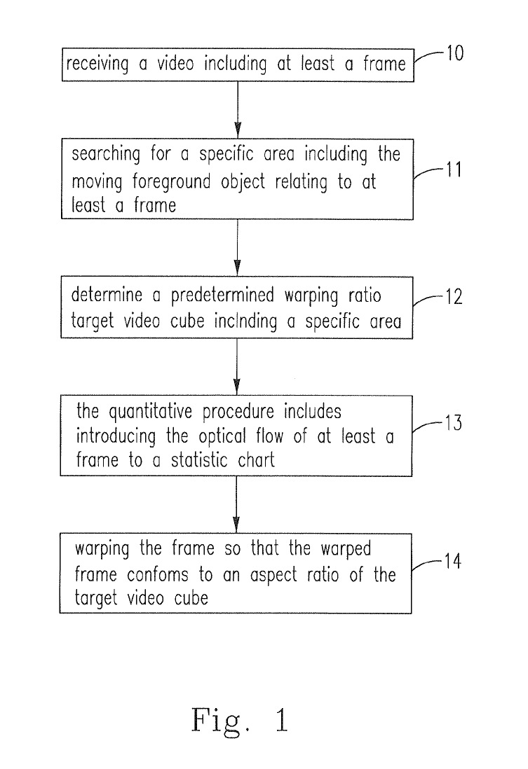

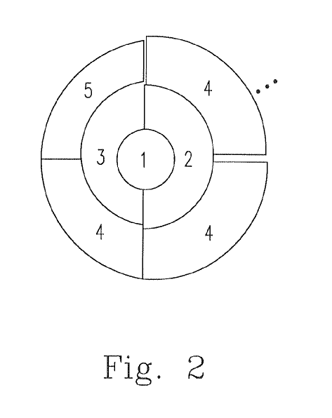

Please see FIG. 1, which is the flow chart of the method of the first embodiment in accordance with the present invention. The processes of the invention are as follow.

Step 10: Receiving video data associated with at least one video frame.

Step 11: Searching for the particular region(s) that the actively moving foreground objects associated with.

Step 12: Determining a pre-warped target video cube including a particular region, wherein the warp ration is determined by human decision.

Step 13: The quantitative procedure includes introducing the optical flow of at least a frame to a statistic chart to perform number counting, and introducing the probability distribution of the numbers to the entropy to obtain the entropy information of at least a column of at least a frame, wherein the particular region is decided by the entropy information.

The horizontal component of the optical flow can indicate whether content moves in or out in the next frame. It is possible to thus take the average flow vector of each pixel column and test whether it came from any of the previous k1 frames and will remain visible in the next k2 frames (e.g., k1=k2=30 in exemplary experiments). If these conditions do not hold, the column can be marked as critical (or particular). Columns that contain actively moving foreground objects (e.g., objects that move independently of the camera motion) can be determined by the entropy of the column's flow. To compute or determine the entropy, it is possible to quantize the flow vectors fᵢ, (iεC where C is the given column pixels) using the common fan chart scheme, where longer vectors can be quantized into more levels (tiny flow vectors typically come from noise and do not require as many quantization bits). I(fᵢ) can denote the integer value associated with the flow vector fᵢ after quantization as Eq. (1):

$$I ( {f}_{i} ) = {2}^{k} + ⌊ \frac{θ ( {f}_{i} )}{2 π / {2}^{k}} ⌋ , with k = ⌊ 0.5 ( {f}_{i} ) ⌋ , \qquad Eq . ( 1 )$$

where L(fᵢ) and θ(fᵢ) can denote the length and orientation of f, respectively. The rationale of this formula is as follows: a fan chart is included of concentric rings of equal width, where the outer radius of ring k is 2(k+1). Ring k can be divided into 2^{k} equal sectors; each sector can span 2π/2^{k} radians. All sectors can be consecutively numbered starting with the innermost one, for example. The origin end of the flow vector can be placed at the origin of the chart. Using exemplary equation (1), it is possible to then compute the sector index in which the tip of the vector will be. Specifically, └θ(fᵢ)/(2π/2^{k})┘k=└0.5 [symbol] (fᵢ)┘ can be the corresponding ring number and can be the particular sector that can land in on the ring.

The present invention utilizes the method of entropy in the information theory to find the left most and the right most boundaries of particular regions. The entropy is defined as: assuming there are multiple events exist in a system S, then S={E₁, E₂, E₃, . . . , Eₙ}, wherein the probability distribution of each event is defined as P={P₁, P₂, P₃, . . . , Pₙ}. Therefore, the equation of the entropy is as following Eq. (2).

$$H ( C ) = - {\sum }_{i ∈ C} P ( {f}_{i} ) \cdot {log}_{2} P ( {f}_{i} ) . \qquad Eq . ( 2 )$$

There are several characteristics in the entropy. Firstly, the entropy value must be greater than zero. Secondly, Assuming N is the total event number in the system S, then the entropy is defined as H_{S}≦log_{b}N. If the equation p₁=p₂= . . . =pₙ is established, the entropy of system S reaches the maximum value, and this is the reason for using the entropy. When the probability of each event is equal, the entropy will reach the maximum value. In the view of the optical flow vector, when the probability distribution is more uniform, each flow vector is more different and means there are important objects moving. In other words, when the probability distributions centralize at a range, that means the flow vectors are the all the same, and the background area is not important. Therefore, the entropy of column C can be obtained via utilizing the quantized flow values, computing the histogram and defining flow probabilities.

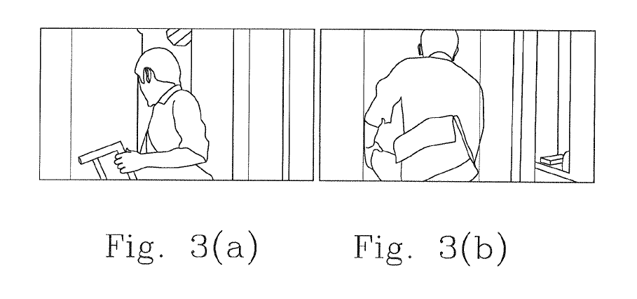

In the present system, it is possible to consider columns with flow entropies larger than 0.7Hm as critical, where Hₘₐₓ is the maximal possible entropy which can occur when the flows are uniformly distributed. FIGS. 3(a)-3(c) show examples of the boundaries of detected critical regions. As shown in FIGS. 3(a)-3(c), the crop boundaries can serve as constraints, or cropping guides in a system according to certain exemplary embodiments of the present disclosure, and not all contents outside will necessarily be fully cropped. The exact amount of cropping can depend on, e.g., the combination with the warping operation and temporal coherence constraints. Therefore, it is possible that explicit extraction of foreground objects is not necessary in en exemplary system since the flow entropy can be a sufficient (preferred, good, etc.) indicator.

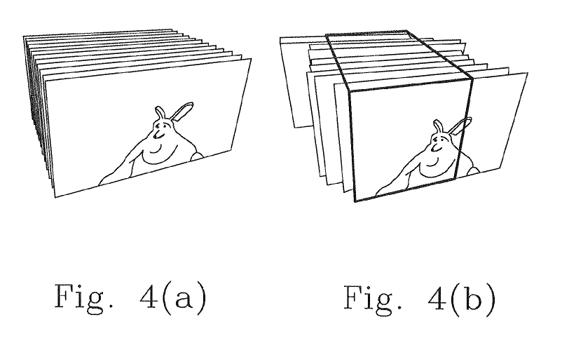

Step 14 is to warp the frames in order to make the processed frames match the size ration of the target video cube as shown in FIGS. 4(a) and 4(b). Step 14 further includes at least an optimization formula to warp the frames in order to make the processed frames match the size ration of the target video cube, and the optimization formula is designed according to spatial contents and the consistency of time.

A video retargeting framework according to certain exemplary embodiments of the present disclosure can be based on a continuous warping function computed by variation optimization, and the cropping operation can be incorporated by adding constraints to the optimization. It is possible to discretize the video cube domain using regular quad grid meshes and define an objective function in terms of the mesh vertices. Minimizing the energy function under certain constraints can result in new vertex positions. The retargeted video can then by reconstructed by interpolating the interior of each quad. The objective function can include several terms that can be responsible for spatial and temporal preservation of visually important content, as well as temporal coherence.

It is possible to represent each video frame t using a grid mesh M^{t}={v^{t}, E, Q}, where V={V=^{t}₁, V=^{t}_{2 . . .} , V=^{t}ₙ} is the set of vertex positions. E and Q can denote the edges and quad faces, respectively (the connectivity can be the same for all frames). The new deformed vertex positions can be denoted by V^{t′}ᵢ=(X^{t′}ᵢ, Y^{t′}ᵢ}, which can be the variables used in an exemplary optimization procedure according to the present disclosure. It is possible to drop (e.g., not use) the superscript t as Vᵢ and simply use V′ᵢ when referring to vertices of a single frame to simplify the notation. The target video size can be denoted by (rₓ, r_{y}, r_{z}), where rₓ and r_{y}, is the target resolution and r_{z} is the number of frames (which can remain unchanged). Conceptually, a goal can be to transform the input video cube into the target cube dimensions without altering the time dimension.

Previous known warping methods likely explicitly prescribed the positions of all (or substantially all) corner vertices in each frame to match the target resolution. According to certain exemplary embodiments of the present disclosure, it is possible to instead design a warp that makes sure that all (or substantially all) critical regions are transformed inside the target video cube dimensions (rₓ, r_{y}, r_{z}). Non-critical regions at the peripheries of the video can be transformed outside of the target cube and thus be cropped out.

The optimization formula includes the conformal energy for preserving spatial contents, the temporal coherence energy for preserving the time consistency at timeline, and the second order smoothing energy for smoothing each frame after cropped. In addition, solving a least-squares problem to obtain a set of optimization result via using the iterative minimization function.

Furthermore, among Step 14, at least a frame is warped based on the grid mesh to preserve the shape of the object in the specific area (the warping slides smoothly on the long axis and wide axis by using the frame, and reduces the accumulation of distortion by cropping the outer unimportant areas). For achieving the time constancy, using the optical flow of at least a geometric unit size of at least a frame to obtain the linear shape transform of at least a geometric unit size, and preserving the time consistency of the linear shaper transform of the at least geometric unit size.

Previous known warping methods likely explicitly prescribed the positions of all (or substantially all) corner vertices in each frame to match the target resolution. According to certain exemplary embodiments of the present disclosure, it is possible to instead design a warp that makes sure that all (or substantially all) critical regions are transformed inside the target video cube dimensions (rₓ, r_{y}, r_{z}). Non-critical regions at the peripheries of the video can be transformed outside of the target cube and thus be cropped out.

For example, V^{t}ₗ and V^{t}ᵣ can denote the mesh vertices closest to the top-left and bottom-right corners of the critical region in frame t, respectively. Exemplary vertices can be chosen conservatively such that the critical region is contained between them. By satisfying the following equation (3), it is possible to force the critical region inside the target cube.

xₗ^{t′}≧0, xᵣ^{t′}≦rₓ,

yₗ^{t′}≧0, yᵣ^{t′}≦r_{y}, for all 0≦t≦r_{z}, Eq. (3)

According to certain exemplary embodiments of the present disclosure, the warping function can be temporally coherent and therefore no need to design separate constraints for the temporal coherence of the cropping region, for example.

To preserve the shape of visually important objects in each frame, it is possible to employ the conformal energy, for example. Each quad can undergo a deformation which is as close as possible to similarity. It is possible for Vᵢ₁, Vᵢ₂, Vᵢ₃ and Vᵢ₄ to be the vertices of an exemplary quad q. Similarity transformations in 2D can be parameterized by four numbers (e.g., s, r, u, v), and it is possible to express the best fitting similarity between q and q′ as Eq. (4):

$${[ s , r , u , v ]}_{q , {q}^{′}} = {argmin}_{s , r , u , v} {\sum }_{j = 1}^{4} {‖ [ \begin{matrix}s & - r \\ r & s\end{matrix} ] {v}_{{i}_{j}} + [ \begin{matrix}u \\ v\end{matrix} ] - {v}_{{i}_{j}}^{′} ‖}^{2} \qquad Eq . ( 4 )$$

Since this is a linear least-squares problem, it is possible to write [s, r, u v]_{q,q′}^{T}=(A_{q}^{T}A_{q})⁻¹A_{q}^{T}b_{b′}, which is as following Eq. (5).

$${A}_{q} = [ \begin{matrix}{x}_{{i}_{1}} & - {y}_{{i}_{1}} & 1 & 0 \\ {y}_{{i}_{1}} & {x}_{{i}_{1}} & 0 & 1 \\ ⋮ & ⋮ & ⋮ & ⋮ \\ {x}_{{i}_{4}} & - {y}_{{i}_{4}} & 1 & 0 \\ {y}_{{i}_{4}} & {x}_{{i}_{4}} & 0 & 1\end{matrix} ] , {b}_{{q}^{′}} = [ \begin{matrix}{x}_{{i}_{1}}^{′} \\ {y}_{{i}_{1} }^{′} \\ ⋮ \\ {x}_{{i}_{4}}^{′} \\ {y}_{{i}_{4}}^{′}\end{matrix} ] . \qquad Eq . ( 5 )$$

The matrix A_{q} can depend solely on the initial grid mesh, and the unknowns can be gathered in b_{q}. By plugging in the expression for [s, r, u, v]_{q,q′} into exemplary as Eq(6):

$${D}_{c} ( q , {q}^{′} ) = {\sum }_{t} {\sum }_{{q}^{t}} {w}_{q}^{t} {D}_{C} ( {q}^{t} , {q}^{{t}^{′}} ) , \qquad Eq . ( 6 )$$

The per-frame spatial importance map can be obtained from the combination of intensity gradient magnitudes and the robust face detection, similarly to previous known warping methods. The exemplary map can be normalized to [0.1, 1.0] to prevent excessive shrinkage of unimportant regions, for example.

The following energy terms from, e.g., Reference No. 28 can be used to prevent strong bending of the mesh grid lines (this can be desirable as salient objects can tend to occupy connected quads) as Eq. (7):

Dₗ=Σₜ(Σ_{{i,j}ε}_{ᵥ}(xᵢ^{t′}−xⱼ^{t′})²+Σ_{{i,j}εE}_{ₕ}(yᵢ^{t′}−yⱼ^{t′})²) Eq. (7)

where Eᵥ and Eₕ can be the sets of vertical and horizontal mesh edges, respectively.

For achieving temporally coherent video resizing, it is possible to use an energy term to preserve the motion information, such that flickering and waving artifacts can be minimized. Given the optical flow, it is possible to determine the evolution of every quad q^{t}ᵢ in the following frame, which can be denoted as Pᵢ^{t+} The best fitting linear transformation Tᵢ^{t} can be found and/or determined such that Tᵢ^{t}(qᵢ^{t})≈pᵢ^{t+1} (it is possible that the translation of Ti does not have to be included since the transformation of the shape of each quad, and not its precise location, can be of interest). An exemplary goal can be to preserve this transformation in the retargeted video using the following exemplary formulated energy term as Eq. (8):

D_{α}(qᵢ^{t})=∥Tᵢ^{t}(qᵢ^{t′})−pᵢ^{t+1′}∥² Eq. (8)

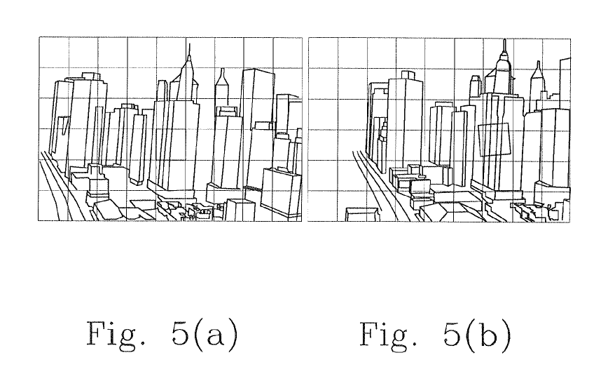

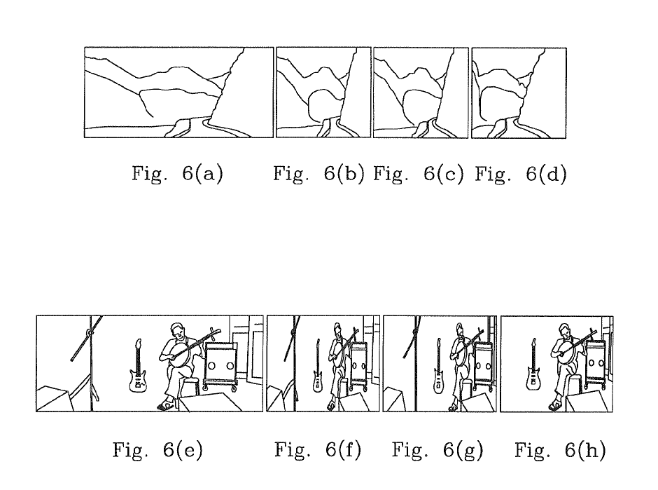

The exemplary relatively simple energy described herein can encompass both motions due to camera and independent object motions, without any need to separately handle the two. It is possible to properly formulate it in terms of unknowns according to the certain exemplary embodiments of the present disclosure, e.g., the mesh vertex positions. By denoting the vertices of pⱼ^{t+1} by Uⱼ^{t+1}, it is possible to represent each of these vertices as a linear combination of the grid mesh vertices V_{d}^{t+1} in the immediate vicinity (see FIGS. 5(a)-5(b)) as Eq. (9):

$${u}_{j}^{t + 1} = {\sum }_{d} {ω}_{d} {v}_{d}^{t + 1} , \qquad Eq . ( 9 )$$

where w_{d} are the barycentric coordinates with respect to the quad vertices V_{d}^{t+1}. Now it is possible to properly reformulate as Eq. (10) in terms of the Vᵢ's:

$${D}_{α} ( {q}_{i}^{t} ) = {\sum }_{( j , k ) ∈ E ( {q}_{i}^{t} )} {‖ {T}_{i}^{t} ( {v}_{j}^{{t}^{′}} - {v}_{k}^{{t}^{′}} ) - ( {u}_{j}^{t + {1}^{′}} - {u}_{k}^{t + {1}^{′}} ) ‖}^{2} , \qquad Eq . ( 10 )$$

where E(qᵢ^{t}) is the set of edges of quad qᵢ^{t}.

There can be a set of quads Q^{t}_{β} which the flow takes outside of the video frame. For such quads, it is possible to constrain their temporally adjacent quads to be similar after resizing, using the following term as Eq. (11):

$${D}_{β} ( {q}_{i}^{t} ) = {\sum }_{( j , k ) ∈ E ( {q}_{i}^{t} )} {‖ ( {v}_{j}^{{t}^{′}} - {v}_{k}^{{t}^{′}} ) - ( {v}_{j}^{t + {1}^{′}} - {v}_{k}^{t + {1}^{′}} ) ‖}^{2} . \qquad Eq . ( 11 )$$

Let Q_{α}^{t}=Q^{t}\Q_{β}^{t}. The overall temporal coherency energy can be as Eq. (12):

$${D}_{t} = {\sum }_{t} {\sum }_{{q}_{i}^{t} ∈ {Q}_{α}^{t}} {D}_{α} ( {q}_{i}^{t} ) + {\sum }_{t} {\sum }_{{q}_{i}^{t} ∈ {Q}_{β}^{t}} {D}_{β} ( {q}_{i}^{t} ) . \qquad Eq . ( 12 )$$

The above-described exemplary energy can preserve temporal coherence of corresponding objects using local constraints as in Eq. (11), which can means that inconsistency can accumulate among frames. To address this problem, it is possible to preserve corresponding quads among farther frames to slow down the error accumulation. For example, in exemplary Eq. (8), it is possible to look at qᵢ^{t}. and its corresponding quad pᵢ^{i+λ} instead of qᵢ^{t} and pᵢ^{t+λ} if their motions are similar (λ=5 in certain exemplary embodiments according to the present disclosure. However, allowing slightly inconsistent resizing can be reasonable (e.g., acceptable) because relatively small changes in objects' shapes can be inconspicuous, in particular when the camera or objects are moving.

In this example, a primary focus of the energies have been with respect to the shape of the resized quads, while globally the video frames have been allowed to slide, which can effectively create an additional “virtual” camera motion. Although such motion can be unavoidable in certain situations, it can be desirable to minimize such motion since artists can usually use camera movement to convey a story, and it can thus be preferred to preserve such motion as much as possible. Therefore, it is possible to pick an anchor vertex (e.g., the top left vertex vo) and constrain its position to change smoothly between neighboring frames. It is possible to accomplish this using the following second-order smoothing term as Eq. (13):

$${D}_{s} = n {\sum }_{t} ‖ 2 {v}_{0}^{{t}^{′}} - {( {v}_{0}^{t - {1}^{′}} + {v}_{0}^{t + {1}^{′}} ‖}^{2} , \qquad Eq . ( 13 )$$

where n can be the number of mesh vertices (this weight can balance the energy term against the other terms that use all mesh vertices and not just a single one, for example).

It is possible to solve for the deformed grid meshes by minimizing as Eq. (14).

D=D_{c}+Dₗ+γDₜ+δDₛ, Eq. (14)

Where γ=10, δ=1.5, subject to boundary constraints. The first exemplary boundary constraint can be the inequality posed by the critical regions; e.g., edge flipping can be an inequality constraint that can prevent self-intersections in the mesh by requiring non-negative length of all mesh edges. Straight boundary constraints can be linear equations making sure the boundaries of the retargeted frames can remain straight (as can be required for top and bottom boundaries of each frame).

Minimizing the objective function expressed as exemplary equation (14) can be a linear least-squares problem under some linear constraints and linear inequality constraints, therefore we employ iterative minimization. For example, it is possible to start the exemplary optimization by placing the leftmost and the rightmost critical columns at the two respective boundaries of the target video cube (these columns can reside in different frames). The optimization can run on the entire video cube at once. In each iteration, it is possible to solve the linear least-squares problem under the linear equality constraints, which can amount to solving a sparse linear system. It is possible to then enforce the detected flipped edges to have zero lengths and also pull the critical columns that turn out to be outside of the target video cube back to the frame boundaries, which can effectively result in new equality constraints for the next iteration. Iterations can continue until all (or substantially all) of the inequality constraints are satisfied. It is also possible to continue until another predetermined criteria is met.

According to certain exemplary embodiments of the present disclosure, the system matrix can change whenever one or more of the constraints change, which can depend on which inequalities were violated. It is possible to apply the GPU-based conjugate gradient solver with a multigrid strategy, which can be more memory- and time-efficient than direct solvers. Once the deformed meshes have been computed, the retargeted video can be produced by “cropping out” the target cube and interpolating the image content inside each quad. In accordance with certain exemplary embodiments of the present disclosure, it is possible to use linear interpolation and/or more advanced methods such as EWA splatting.

A procedure according to certain exemplary embodiments of the present disclosure was tested on a desktop PC with Duo 2.33 GHz CPU and Nvidia GTX 285 graphics card. The method was then applied to crop videos into short clips according to scene changes. Different scenes were retargeted independently since temporal coherence is not necessary when the contents are disjointed. This strategy can improve the performance and memory consumption since the computational complexity can be quadratic in the number of unknown vertex positions. To trade quality for efficiency, it is possible to use grid meshes with 20×20 pixels per quad, as was used in certain experiments according to certain exemplary embodiments of the present disclosure, as described herein. A retargeting system according to certain exemplary embodiments of the present disclosure can take 2 to 3 iterations on average, which can depend on the video content, when solving the constrained optimization. A multigrid strategy can be used to satisfy the inequality constraints on coarser levels in order to improve the performance when deforming finer meshes. For example, a system can according to certain exemplary embodiments of the present disclosure can achieve about 6 frames per second on average when retargeting a 200-frames video with resolution of 688×288 pixels, and the performance can naturally drop for larger numbers of frames.

The above-mentioned results shown in the figures are illustrations that show exemplary results to demonstrate the effectiveness of a procedure in accordance with certain exemplary embodiments of the present disclosure. Certain exemplary results were generated automatically using exemplary default parameters of the procedure according to certain exemplary embodiments of the present disclosure. In some cases, users can want to manually emphasize important objects. This can be achieved by, e.g., segmenting the objects using a graph-cut technique in one frame, and automatically propagating the segmentation to subsequent frames via an associated optical flow.

A procedure according to certain exemplary embodiments of the present disclosure was compared with linear scaling, with the motion-aware retargeting (MAR) procedure and with the streaming video retargeting (SVR) procedure. MAR and SVR were used in the comparison since these procedures that have relatively recently been known. It is believed that preceding methods cannot handle temporal motion coherence in video resizing and therefore would likely inevitably not compare favorably with motion-aware methods, which assessment was widely supported by a conventional user study. While the image retargeting techniques can combine cropping and other operations in attempting to optimize an image similarity metric, these methods can be significantly more costly for still images and have apparently not been extended to videos in a temporally-coherent manner.

One publication for comparison, MAR can be reviewed because it can address temporal coherence. Since this publication can require camera alignment, which can rely on SIFT features, it can fail on videos with homogeneous backgrounds, as shown in FIGS. 7(a)-7(d), wherein FIG. 7 (a) is an exemplary illustrations of the conventional methods, FIG. 7(b) showing the linear scaling frame, FIG. 7 (c) is the figure processed in the prior art, and FIG. 7 (d) shows the embodiment in accordance with the present invention.

Moreover, when true perspective effects such as parallax are present, the MAR method likely cannot coherently transform corresponding objects with different depths, in Which case the result can degenerate to linear scaling, as shown in FIGS. 6(a)-6(h), wherein FIGS. 6 (a) and 6(e) are exemplary illustrations of the conventional methods, FIGS. 6(b) and 6(f) showing the linear scaling frames, FIGS. 6 (c) and 6(g) are the figures processed in the prior art, and FIGS. 6 (d) and 6(h) show the embodiments of the present invention. In contrast, a procedure according to certain exemplary embodiments of the present disclosure can seamlessly handle all (or substantially all) types of motion without requiring camera alignment, and therefore can succeed on scenes with arbitrary depth variability and camera motion.

The pixel-level SVR method can also achieve video resizing in real time. To obtain such performance, SVR likely addressed the warping optimization problem on each frame separately, merely constraining temporally-adjacent pixels to be transformed consistently. Temporal coherence with SAR can be addressed by averaging the per-frame spatial importance maps over a window of 5 frames and augmenting them with motion saliency (e.g., extracted from optical flow), such that visually prominent and moving objects can get higher importance. However, per-frame resizing likely cannot avoid waving artifacts when large camera and dynamic motions are present. In a system according to certain exemplary embodiments of the present disclosure, it is possible to preserve temporal coherence by, e.g., sacrificing real-time efficiency and per-pixel quality and use coarser grid meshes. This can make it possible to optimize all (or at least more) video frames simultaneously.

Apart from previous state-of-the-art warp-based retargeting methods, also provided herein is a comparison to a manually-generated cropping result, which should be at least as good as an automatic result). Certain advantages of warping in general should be obvious to one having ordinary skill in the art, in particular in the challenging examples where the aspect ratio of the video can be significantly altered. As shown by the exemplary results illustrated in the appended Figures and described herein, the width was reduced by about 50%, and using any substantial cropping alone can suffer from significant object removal or cutting artifacts in the examples.

Employing finer or pixel-level mesh resolutions in a procedure according to certain exemplary embodiments of the present disclosure can yield even better results than employing coarser resolutions at least because the saliency and motion information would likely be more accurately considered. However, the quality improvement when using finer grids can be less significant since the contents of each quad can often be homogeneous. Experiments in accordance with certain exemplary embodiments of the present disclosure have included using different grid resolutions. Although the computation and memory costs can significantly increase, the retargeted videos can look similar when the meshes are sufficiently dense. For example, using a grid of 20×20-pixel quads can be a preferred compromise between quality and performance.

A procedure according to certain exemplary embodiments of the present disclosure was evaluated by conducting a user study with 96 participants having diverse backgrounds and ages. The conventional study setup was closely followed, taking the paired comparisons approach). For example, participants were presented with an original video sequence and two retargeted versions side by side, and they were asked to answer which retargeted version they prefer. The users were not informed about the purpose of the experiment and were not provided with any special technical instructions. Six different videos were used in the experiment, and each video was retargeted to about 50% width using fully automatic versions of SVR, MAR and a procedure according to certain exemplary embodiments of the present disclosure. Therefore, for each video, there were 3 pairwise comparisons, and each participant was asked to make 18 comparisons (3×6). The videos were selected to include relatively diverse scene types and motion types, e.g., live action footage and CG films, close-ups and wide angle views, single foreground object and several objects, fast moving and slow moving camera, and clips with and without parallax effects. Videos from five commercial feature films and one CG animated short were used. The selection of videos was based on having a high variety while keeping the number of clips low, since each clip added 3 more comparisons and it could not be expected that each user would spend more than about 20-30 minutes total on their participation in the experiment. Questions were presented in random order to avoid bias. A total of 1728 (18×96) answers were obtained, and each method was compared 1152 times (2×6×96).

Exemplary Table 1

| was preferred | Exemplary | | | |
|---|---|---|---|---|
| over | Procedure | MVR | SVR | Total |
| Exemplary | — | 488 | 508 | 996 |
| Procedure | | | | |
| MVR | 88 | — | 309 | 397 |
| SVR | 68 | 267 | — | 335 |

Exemplary Table 1 shows pairwise comparison results of 96 user study participants. A total of 1728 comparisons were performed. In this example, entry ay in the middle portion of the table means method i was preferred au times over method j.

As shown in Table 1, the summary of the obtained results supports a significant preference of the procedure according to certain exemplary embodiments of the present disclosure. Overall, the exemplary procedure was preferred in 86.5% (996/1152) of the times it was compared. It was favored over SVR in 88.2% and over MAR in 84.7% of the comparisons. In contrast, SVR was favored only in 29.1% (335/1152) and MAR in 34.5% (397/1152) of the comparisons. The participants tended to agree in their choices. measured Kendall's coefficient of agreement was measured with μ=0.356, which was statistically significant to p<0.01, for example. Kendall's coefficient of consistence indicated that the number of circular triads 1→2→3→1 meaning statistical inconsistency of preferences of an individual user was ξ=1 for 15 about 78% of the users, e.g., they were completely consistent. The average consistency coefficient was relatively high, ξ̅=0.94 with a standard deviation of 0.1, and only 3 users had consistency score ξ=0.5.

According to a conventional user study, the SVR method was shown to be significantly preferred over linear scaling and methods. Additional experiments can include conducting a further perceptual experiment and/or study comparing additional retargeting operators on more video sequences, which can involve a more complex experiment design and more participants, for example. It can also be preferable and/or useful to compare with a no-reference study (e.g., where the participants do not see the original-size video). Reference videos were included in the experiment described herein to determine whether users would be bothered by the cropping component of a system according to certain exemplary embodiments of the present disclosure, such as the disappearance of important objects for a period of time. However, based on the exemplary results of the experiment described herein, the presence and/or absence of the original video does not seem to alter the results, which can be because people likely tend to ignore the reference video and concentrate on the two side-by-side results.

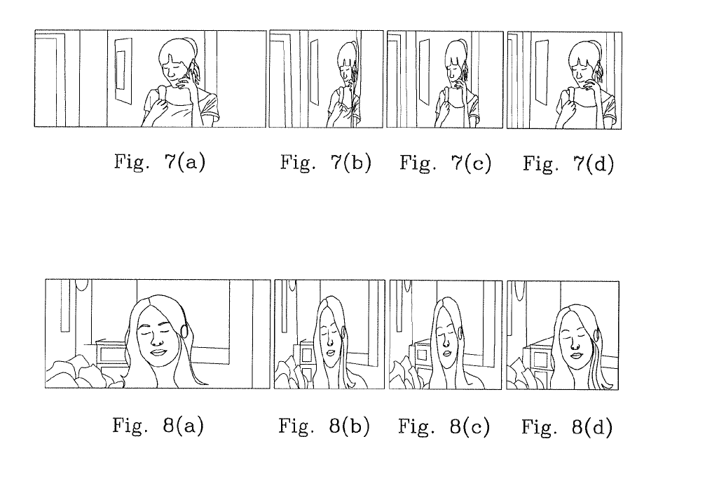

As described herein above, preservation of temporal behavior and spatial form of salient objects can be two conflicting goals. If the trajectory of an important object covers most of the frame, e.g., the object overlaps all (or most) background regions at some point in time, preserving temporal coherence can mean consistently resizing both the object and the entire background, and the only warping operator that can achieve this likely can be linear scaling. A procedure according to certain exemplary embodiments of the present disclosure can automatically pursue a temporal tradeoff in this case, e.g., the exemplary procedure can crop some areas for a part of the period the objects are visible. As shown in FIGS. 8(a)-8(d), wherein FIG. 8(a) is an exemplary illustration of the conventional methods, FIG. 8(b) showing the linear scaling frame, FIG. 8(c) is the figure processed in the prior art, and FIG. 8(d) shows the embodiment in accordance with the present invention a camera path orbits (circles) around the main subject (woman) such that almost all foreground and background regions are correlated. Compared to the pure cropping, the preservation of motion in critical regions using the exemplary procedure can provide for important objects persisting in target videos. In addition, the combination with warping can reduce the introduced virtual camera motion. In many examples, there can be sufficiently many available homogeneous regions that absorb the warping distortion, such that cropping does not have to be used to the full extent and thus not be noticeable. A balance between cropping and warping can be automatically decided by the variational optimization, for example.

Although the exemplary procedure can expand the distortion propagation to the temporal dimension, as opposed to just the spatial domain, retargeting videos with many prominent features and active foregrounds can still produce distortions, both spatially and temporally, as shown in FIGS. 9(a)-9(d), wherein FIG. 9(a) is an exemplary illustrations of the conventional methods, FIG. 9(b) showing the linear scaling frame, FIG. 9(c) is the figure processed in the prior art, and FIG. 9(d) shows the embodiment in accordance with the present invention. In such extreme cases, additional input as to the definition of critical regions in key frames can be utilized, e.g., letting users decide which objects can be permanently cropped out. Similarly, it is possible that automatic cropping criterion can be less effective for extreme tilting camera motion that can result in prominent objects having to be cropped forever. Exemplary embodiments according to the present disclosure can be flexible and admit various cropping constraints so that specific criteria for cropping with tilting motion can be designed, for example. Additionally, a procedure according to certain exemplary embodiments of the present disclosure can utilize accurate motion information. Most detection methods can likely not always be able to distinguish between noise and lighting, which can cause certain exemplary embodiments of a procedure according to the present disclosure to preserve motion of less relevant parts of the content and/or extend their persistence.

It is also possible that a procedure according to certain exemplary embodiments of the present disclosure can apply coarse grid meshes to retarget videos that can result in each quad of the mesh containing several layers of objects moving independently. In such a case, the quad transformation can be insufficient to fully represent the interior motions. This can be counteracted through continuous warping, which can have a high error tolerance, such that the resulting local waving artifacts can be significantly less noticeable. Additionally, using a pixel-level grid can help eliminate this problem altogether.

Further, computational costs can be addressed to enable a procedure according to certain exemplary embodiments of the present disclosure to facilitate greater length and resolution of videos that can be processed. The scalability of the system can also be expanded by using a streaming approach with a sliding window, similarly to that in prior arts, although it is possible that such approach can potentially lead to temporal incoherence.

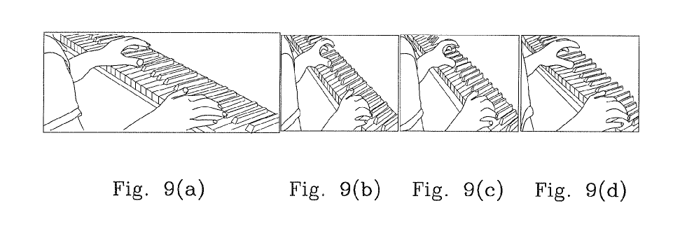

FIG. 10 shows an exemplary block diagram of an exemplary embodiment of a system according to the present disclosure. For example, an exemplary procedure in accordance with the present disclosure can be performed by a processing arrangement and/or a computing arrangement 20. Such processing/computing arrangement 20 can be, e.g., entirely or a part of, or include, but not limited to, a computer/processor 21 that can include, e.g., one or more hardware processors and/or microprocessors, and use instructions stored on a computer-accessible medium (e.g., RAM, ROM, hard drive, or other storage device).

As shown in FIG. 10, e.g., a computer-accessible medium 23 (e.g., as described herein above, a storage device such as a hard disk, floppy disk, memory stick, CD-ROM, RAM, ROM, etc., or a collection thereof) can be provided (e.g., in communication with the processing arrangement 20). The computer-accessible medium 23 can contain executable instructions 24 thereon. In addition or alternatively, a storage arrangement 25 can be provided separately from the computer-accessible medium 23, which can provide the instructions to the processing arrangement 20 so as to configure the processing arrangement to execute certain exemplary procedures, processes and methods, as described herein above, for example.

Further, the exemplary processing arrangement 20 can be provided with or include an input/output arrangement 22, which can include, e.g., a wired network, a wireless network, the internet, an intranet, a data collection probe, a sensor, etc. As shown in FIG. 10, the exemplary processing arrangement 20 can be in communication with an exemplary display arrangement 26, which, according to certain exemplary embodiments of the present disclosure, can be a touch-screen configured for inputting information to the processing arrangement in addition to outputting information from the processing arrangement, for example. Further, the exemplary display 26 and/or a storage arrangement 25 can be used to display and/or store data in a user-accessible format and/or user-readable format.

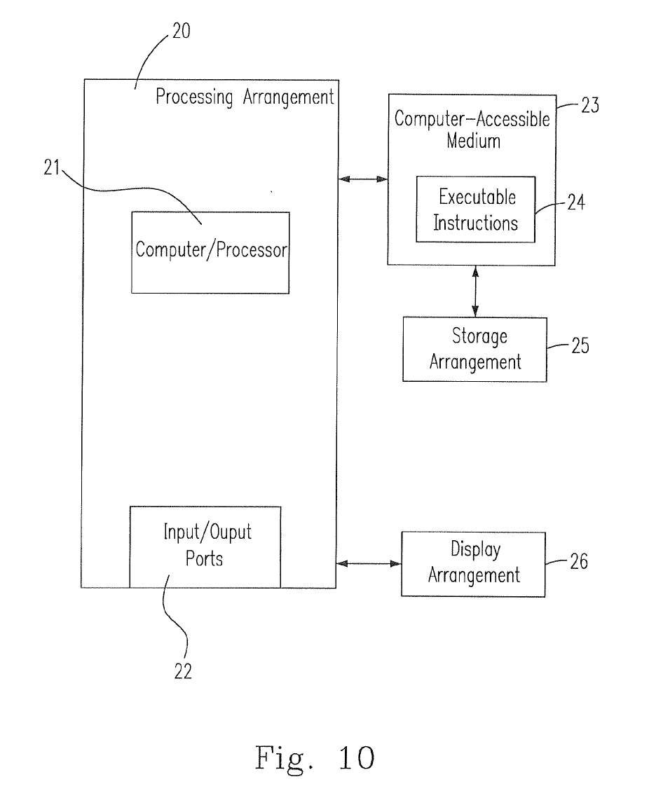

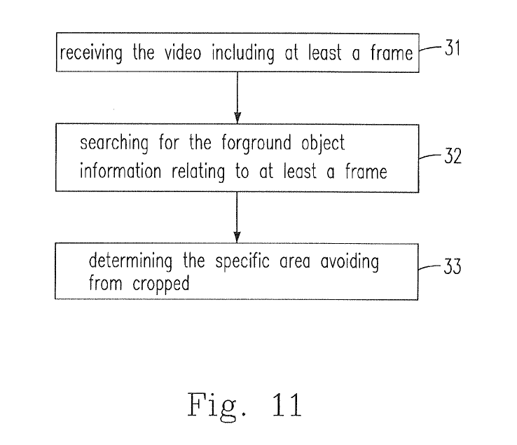

FIG. 11 shows a flow diagram of a procedure in accordance with certain exemplary embodiments of the present disclosure. As shown in FIG. 11, the exemplary procedure can be executed on and/or by, e.g., the processing/computing arrangement 20. Firstly, receiving the video including at least a frame (Step 31); secondly, searching for the foreground object information relating to at least a frame (Step 32); and determining the specific area avoiding from cropped (Step 33).

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and methods which, although not explicitly shown or described herein, embody the principles of the disclosure and are thus within the spirit and scope of the disclosure. In addition, all publications and references referred to above are incorporated herein by reference in their entireties. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words are intended to not be used synonymously. Further, to the extent that the prior art knowledge has not been explicitly incorporated by reference herein above, it is explicitly being incorporated herein in its entirety. All publications referenced above are incorporated herein by reference in their entireties.

As described here, provided herein are exemplary embodiments of apparatus, systems, computer-accessible medium, methods and procedures for, e.g., identifying particular regions in video content to be protected from cropping during video retargeting. Motion can play a significant role in video and distinguish video retargeting from still image resizing. Based on the observation that motion can dictate the temporal dimension of the retargeting problem and define the visually prominent content in video, certain exemplary embodiments according to the present disclosure can utilize optical flow to guide the retargeting process, using it for spatial components (temporally-coherent warping) and for temporal decisions (persistence based cropping), for example.

Since analysis and optimization over the entire video sequence up to scene cuts can be significant aspect of a procedure according to certain exemplary embodiments of the present disclosure, the computational cost can be relatively higher than that of real-time systems which only utilize per-frame optimization. As one having ordinary skill in the art should appreciate in light of the present disclosure, such computational costs can be a nominal issue, resulting in exemplary embodiments according to the present disclosure providing for high-quality video processing results.

The foregoing merely illustrates the principles of the present disclosure. Various modifications and alterations to the described embodiments will be apparent to those having ordinary skill in art the in view of the teachings herein. It will thus be appreciated that those having ordinary skill in art will be able to devise numerous systems, arrangements, and methods which, although not explicitly shown or described herein, embody the principles of the disclosure and are thus within the spirit and scope of the disclosure. In addition, all publications and references referred to above are incorporated herein by reference in their entireties. It should be understood that the exemplary procedures described herein can be stored on any computer accessible medium, including a hard drive, RAM, ROM, removable disks, CD-ROM, memory sticks, etc., and executed by a processing arrangement which can be a microprocessor, mini, macro, mainframe, etc. In addition, to the extent that the prior art knowledge has not been explicitly incorporated by reference herein above, it is explicitly being incorporated herein in its entirety. All publications referenced above are incorporated herein by reference in their entireties.

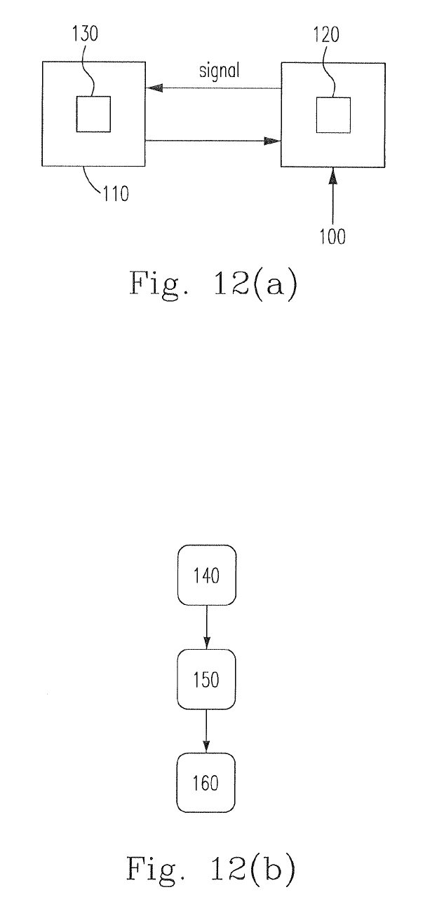

The descriptions of the video playing system of displays are as follows. As shown in FIG. 12(a), the video playing system 100 of the present invention includes a display 120, another server end 110, and the server end usually comprises a processor 130. When applying the method of the present application, the video playing system 100 performs steps 140, 150 and 160 after the server end 110 receives a video signal as FIG. 12(b). The above threes steps are: receiving a video having at least a frame having a specific area; defining a target video cube having a predetermined warping ratio and including the specific area; and warping the frame so that the warped frame conforms to an aspect ratio of the target video cube. The video having a new format for being transferred to the display 120 can be obtained after finishing the above three steps.

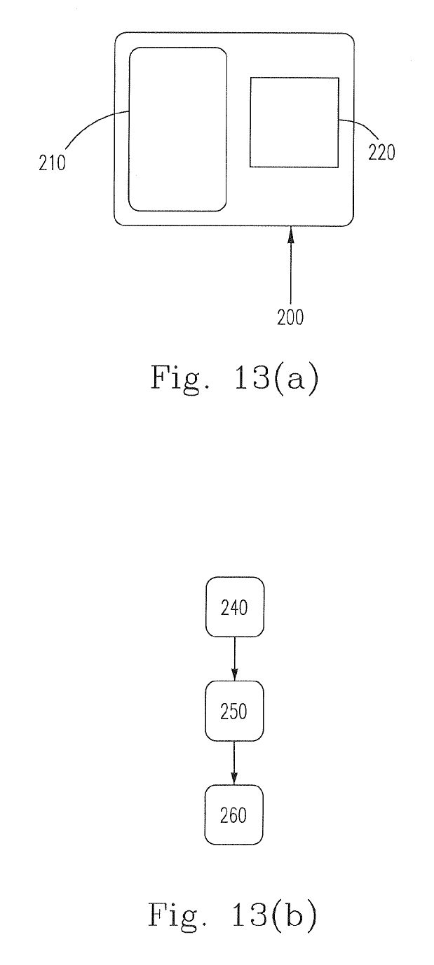

The descriptions of the video data processing system of displays are as follows. As shown in FIG. 13(a), the video data processing system 200 of the present invention includes a video interface 210 for providing formats to a series of images, and an embedded system 220 for receiving and performing the series of images. When applying the method of the present application, the video data processing system 200 performs steps 240, 250 and 260 after the embedded system 220 receives a video signal as FIG. 13(b). The above threes steps are: receiving a video having at least a frame having a specific area; defining a target video cube having a predetermined warping ratio and including the specific area; and warping the frame so that the warped frame conforms to an aspect ratio of the target video cube. The format of another series of images can be output after finishing the above three steps.

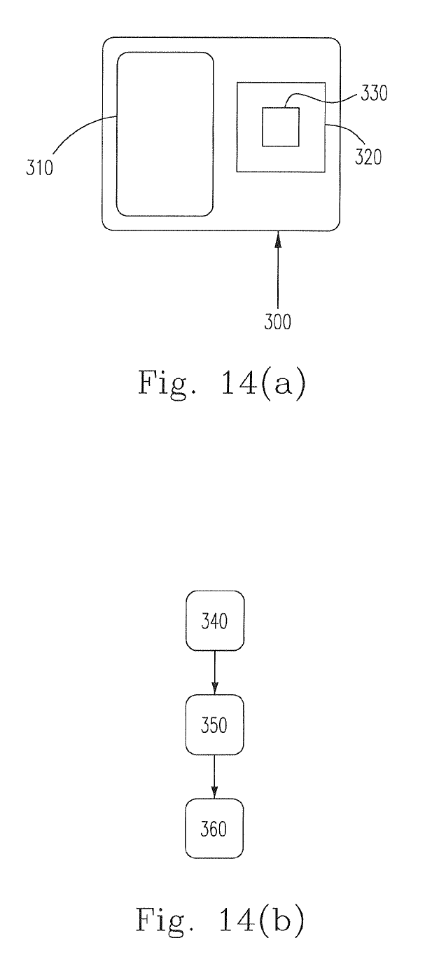

The descriptions of the video playing system of displays are as follows. As shown in FIG. 14(a), the touch control system 300 of the present invention includes a touch panel 310 for utilizing outer touch command to generate a video output format, and a graphic processing unit 320, wherein the graphic processing unit 320 further includes an execution unit 330. When applying the method of the present application, the touch system 300 performs steps 340, 350 and 360 after the execution unit 330 receives an outer touch command as FIG. 14(b). The above threes steps are: receiving a video having at least a frame having a specific area; defining a target video cube having a predetermined warping ratio and including the specific area; and warping the frame to output a predetermined video output format. The format of another series of images can be output after finishing the above three steps.

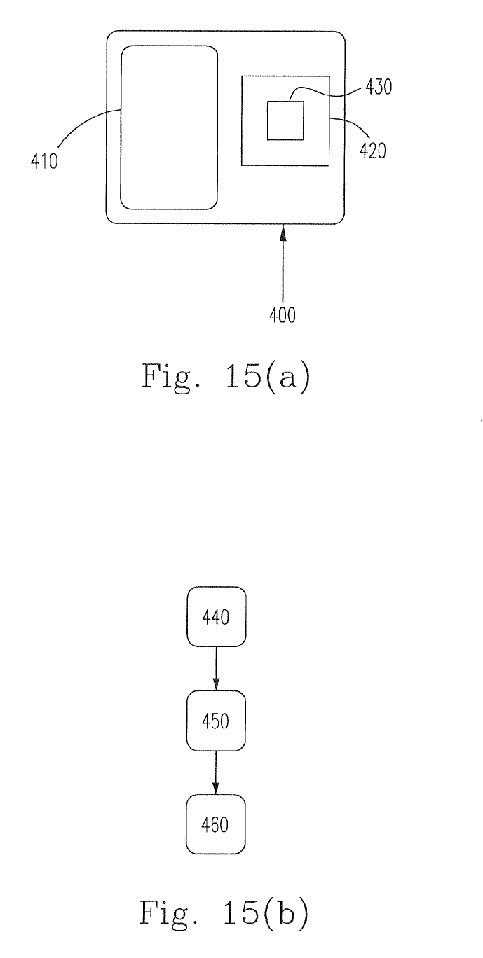

The descriptions of the video playing system of displays are as follows. As shown in FIG. 15(a), the video output format system 400 of the present invention includes an outer input command 410 for generating an outer command relating to a video output format, a graphic processing device 420, wherein the graphic processing device 420 further includes an execution unit 430. When applying the method of the present application, the output format system 400 performs steps 440, 450 and 660 after the execution unit 430 the outer command as FIG. 15(b). The above threes steps are: receiving a video having at least a frame having a specific area; defining a target video cube having a predetermined warping ratio and including the specific area; and warping the frame so that the warped frame conforms to an aspect ratio of the target video cube to output a predetermined video output format.

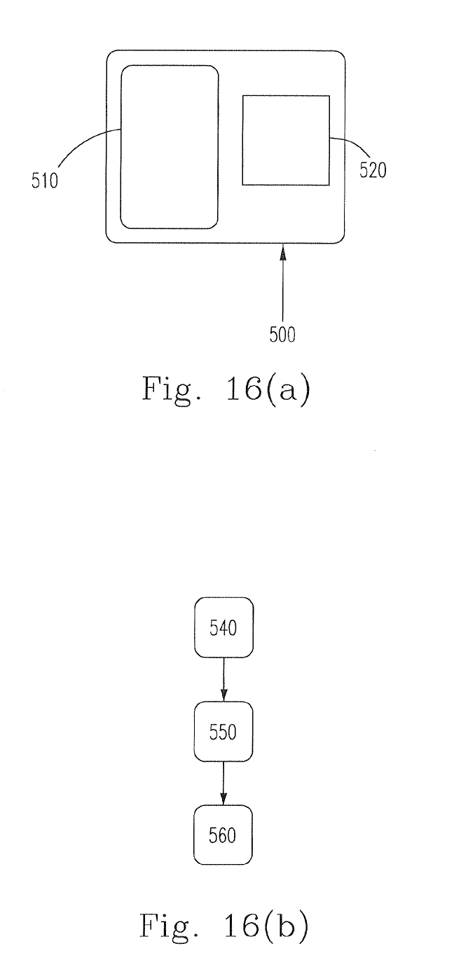

The descriptions of the video playing system of displays are as follows. As shown in FIG. 16(a), the warping graphic processing unit 500 of the present invention includes a memory unit 510 and a processing unit 520. When applying the method of the present application, the graphic processing unit 500 performs steps 540, 550 and 560 as FIG. 16(b). The above threes steps are: the memory unit 510 receives a video having at least a frame having a specific area; the processing unit 520 defines a target video cube having a predetermined warping ratio and including the specific area; and warping the frame so that the warped frame conforms to an aspect ratio of the target video cube.

The more detailed applications about steps 140, 150, 160, 240, 250, 260, 340, 350, 360, 440, 450, 460, 540, 550 and 560 can be viewed in the following embodiments of the present application.

### EMBODIMENTS

### Embodiment 1

A method for warping a video, including steps of (a) receiving a video having at least a frame having a specific area; (b) defining a target video cube having a predetermined warping ratio and including the specific area; and (c) warping the frame so that the warped frame conforms to an aspect ratio of the target video cube.

### Embodiment 2

A method as claimed in Embodiment 1, further including a step subsequent to the step (a): defining the respective specific area containing a moving foreground object associated with the frame.

### Embodiment 3

A method as claimed in Embodiments 1-2, further including a step of defining and quantifying an optical flow of the frame to obtain a flow vector resulting from the quantification, wherein the respective specific area is determined based on an entropy associated with the flow vector.

### Embodiment 4

A method as claimed in Embodiments 1-3, wherein the entropy is determined based on a flow probability of the flow vector.

### Embodiment 5

A method as claimed in Embodiments 1-4, wherein the predetermined warping ratio is determined by a user.

### Embodiment 6

A method as claimed in Embodiments 1-5, wherein the step of warping is performed by using an optimization formula based on a spatial content and a temporal coherence.

### Embodiment 7

A method as claimed in Embodiments 1-6, wherein the optimization formula is a function of at least one selected from a group consisting of a conformal energy for maintaining the spatial content, a temporal coherence energy at a time axis, and a second-order smoothing energy for smoothing the respective frame after being cropped.

### Embodiment 8

A method as claimed in Embodiments 1-7, further including a step of obtaining an optimized result is obtained by resolving a least-squares issue on an iterative minimization function of the energy.

### Embodiment 9

A method as claimed in Embodiments 1-8, wherein the at least one frame is unevenly warped in accordance with a grid mesh structure thereof using a geometric unit dimension.

### Embodiment 10

A method as claimed in Embodiments 1-9, further including steps of obtaining a linear deformation of the geometric unit dimension based on an optical flow thereof, and maintaining a consistence of the linear deformation of the geometric unit dimension during the warping, to achieve a temporal coherence.

### Embodiment 11

A method as claimed in Embodiments 1-10, wherein the warping is performed by using a frame edge sliding along a horizontal axis and a vertical axis.

### Embodiment 12

A method of film processing, including steps of (a) receiving a film having at least a frame; (b) defining a three-dimensional image coordination of a target film having a predetermined warping ratio and a specific area; and (c) warping the frame so that the warped frame conforms to the three-dimensional image coordination.

### Embodiment 13

A system for playing a film, including a processor performing steps of (a) receiving the film having at least a frame; (b) defining a three-dimensional image coordination of a target film having a predetermined warping ratio and a specific area; and (c) warping the frame so that the warped frame conforms to the three-dimensional image coordination, and the film has a new format for playing.

### Embodiment 14

A system for playing a film, including a processor performing steps of (a) receiving a plurality of frames; (b) defining a predetermined warping ratio proper to a respective specific area of each the frame; and (c) warping the each frame so that the respective warped frame thereof conforms to the respective predetermined warping ratio, and the film has a new format for playing.

### Embodiment 15

A system for processing a data of a film, including an embedded system performing steps of (a) receiving a plurality of frames having a first format; (b) defining a predetermined warping ratio proper to a respective specific area of each the frame; and (c) warping the each frame so that the respective warped frame thereof conforms to the predetermined warping ratio, and the film has a second format for playing.

### Embodiment 16

A system for processing a data of a film, including an embedded system performing steps of (a) receiving a plurality of frames having a target image of a first format; (b) defining a target rectangular parallelepiped, wherein the target rectangular parallelepiped has a two-dimensional size to contain the target image and a third dimension being a unit time, and the unit time is a time span between two adjacent frames of the plurality of frames; and (c) warping the target image into the target rectangular parallelepiped so that the film has a second format for playing.

### Embodiment 17

A touch panel system, including a touch panel generating a first video format based on an external touch-controlled instruction; and an implementation unit receiving the external touch-controlled instruction, and performing steps of (a) receiving a plurality of frames having a target image; (b) defining a target rectangular parallelepiped, wherein the target rectangular parallelepiped has a two-dimensional size to contain the target image and a third dimension being a unit time, and the unit time is a time span between two adjacent frames of the plurality of frames; and (c) warping the target image into the target rectangular parallelepiped to generate a second video format different from the first video format for playing.

### Embodiment 18

A system for processing a video output format, including an external input instruction generating an external command associated with a video output format; and an implementation unit receiving the external command, and performing steps of (a) receiving a plurality of frames having a target image; (b) defining a target rectangular parallelepiped, wherein the target rectangular parallelepiped has a two-dimensional size to contain the target image and a third dimension being a unit time, and the unit time is a time span between two adjacent frames of the plurality of frames; and (c) warping the target image into the target rectangular parallelepiped to generate a new format for playing, wherein the new format is different from the video output format.

### Embodiment 19

A graphic processor for warping a film, including a memory unit receiving the film having at least a frame; and a processing unit performing steps of (a) defining a three-dimensional image coordination of a target film having a predetermined warping ratio and a specific area; and (b) warping the frame so that the warped frame conforms to the three-dimensional image coordination, and the film has a new format for playing.

### Embodiment 20

A graphic processor for warping a film, including a memory unit receiving the film having at least a frame; and a processing unit performing steps of (a) receiving a plurality of frames having a target image; (b) defining a target rectangular parallelepiped, wherein the target rectangular parallelepiped has a two-dimensional size to contain the target image and a third dimension being a unit time, and the unit time is a time span between two adjacent frames of the plurality of frames; and (c) warping the target image into the target rectangular parallelepiped so that the film has a new format for playing.

What is claimed is:

1. A method for warping a video, comprising steps of:
(a) receiving a video having at least a frame having a specific area;
(b) defining a target video cube having a predetermined warping ratio and including the specific area; and
(c) warping the frame so that the warped frame conforms to an aspect ratio of the target video cube.

2. A method as claimed in claim 1, further comprising a step subsequent to the step (a): defining the respective specific area containing a moving foreground object associated with the frame.

3. A method as claimed in claim 2, further comprising a step of defining and quantifying an optical flow of the frame to obtain a flow vector resulting from the quantification, wherein the respective specific area is determined based on an entropy associated with the flow vector.

4. A method as claimed in claim 3, wherein the entropy is determined based on a flow probability of the flow vector.

5. A method as claimed in claim 1, wherein the predetermined warping ratio is determined by a user.

6. A method as claimed in claim 1, wherein the step of warping is performed by using an optimization formula based on a spatial content and a temporal coherence.

7. A method as claimed in claim 6, wherein the optimization formula is a function of at least one selected from a group consisting of a conformal energy for maintaining the spatial content, a temporal coherence energy at a time axis, and a second-order smoothing energy for smoothing the respective frame after being cropped.

8. A method as claimed in claim 7, further comprising a step of obtaining an optimized result is obtained by resolving a least-squares issue on an iterative minimization function of the energy.

9. A method as claimed in claim 1, wherein the at least one frame is unevenly warped in accordance with a grid mesh structure thereof using a geometric unit dimension.

10. A method as claimed in claim 9, further comprising steps of obtaining a linear deformation of the geometric unit dimension based on an optical flow thereof, and maintaining a consistence of the linear deformation of the geometric unit dimension during the warping, to achieve a temporal coherence.

11. A method as claimed in claim 1, wherein the warping is performed by using a frame edge sliding along a horizontal axis and a vertical axis.

12. A method of film processing, comprising steps of:
(a) receiving a film having at least a frame;
(b) defining a three-dimensional image coordination of a target film having a predetermined warping ratio and a specific area; and
(c) warping the frame so that the warped frame conforms to the three-dimensional image coordination.

13. A system for playing a film, comprising:
a processor performing steps of:
(a) receiving the film having at least a frame;
(b) defining a three-dimensional image coordination of a target film having a predetermined warping ratio and a specific area; and
(c) warping the frame so that the warped frame conforms to the three-dimensional image coordination, and the film has a new format for playing.

14. A system for playing a film, comprising:
a processor performing steps of:
(a) receiving a plurality of frames;
(b) defining a predetermined warping ratio proper to a respective specific area of each the frame; and
(c) warping the each frame so that the respective warped frame thereof conforms to the respective predetermined warping ratio, and the film has a new format for playing.

15. A system for processing a data of a film, comprising:
an embedded system performing steps of:
(a) receiving a plurality of frames having a first format;
(b) defining a predetermined warping ratio proper to a respective specific area of each the frame; and
(c) warping the each frame so that the respective warped frame thereof conforms to the predetermined warping ratio, and the film has a second format for playing.

16. A system for processing a data of a film, comprising:
an embedded system performing steps of:
(a) receiving a plurality of frames having a target image of a first format;
(b) defining a target rectangular parallelepiped, wherein the target rectangular parallelepiped has a two-dimensional size to contain the target image and a third dimension being a unit time, and the unit time is a time span between two adjacent frames of the plurality of frames; and
(c) warping the target image into the target rectangular parallelepiped so that the film has a second format for playing.

17. A touch panel system, comprising:
a touch panel generating a first video format based on an external touch-controlled instruction; and
an implementation unit receiving the external touch-controlled instruction, and performing steps of:
(a) receiving a plurality of frames having a target image;
(b) defining a target rectangular parallelepiped, wherein the target rectangular parallelepiped has a two-dimensional size to contain the target image and a third dimension being a unit time, and the unit time is a time span between two adjacent frames of the plurality of frames; and
(c) warping the target image into the target rectangular parallelepiped to generate a second video format different from the first video format for playing.

18. A system for processing a video output format, comprising:
an external input instruction generating an external command associated with a video output format; and
an implementation unit receiving the external command, and performing steps of:
(a) receiving a plurality of frames having a target image;
(b) defining a target rectangular parallelepiped, wherein the target rectangular parallelepiped has a two-dimensional size to contain the target image and a third dimension being a unit time, and the unit time is a time span between two adjacent frames of the plurality of frames; and
(c) warping the target image into the target rectangular parallelepiped to generate a new format for playing, wherein the new format is different from the video output format.

19. A graphic processor for warping a film, comprising:
a memory unit receiving the film having at least a frame; and
a processing unit performing steps of:
(a) defining a three-dimensional image coordination of a target film having a predetermined warping ratio and a specific area; and
(b) warping the frame so that the warped frame conforms to the three-dimensional image coordination, and the film has a new format for playing.

20. A graphic processor for warping a film, comprising:
a memory unit receiving the film having at least a frame; and
a processing unit performing steps of:
(a) receiving a plurality of frames having a target image;
(b) defining a target rectangular parallelepiped, wherein the target rectangular parallelepiped has a two-dimensional size to contain the target image and a third dimension being a unit time, and the unit time is a time span between two adjacent frames of the plurality of frames; and
(c) warping the target image into the target rectangular parallelepiped so that the film has a new format for playing.
